(19) United States
(12) Patent Application Publication
(10) Pub. No.: US 2025/0327554 A1
(43) Pub. Date: Oct. 23, 2025

(54) COMPOSITE COMPONENT, LIGHTING DEVICE, AND STRUCTURAL UNIT FOR A MOTOR VEHICLE, AND METHOD FOR PRODUCING THE COMPOSITE COMPONENT

(71) Applicant: HELLA GMBH & CO. KGAA, Lippstadt (DE)

(72) Inventors: Odo Karger, Geseke (DE); Sven Kinkel, Borchen (DE); Michael Lakenbrink, Oelde (DE); Peter Schmidt, Lippstadt (DE)

(21) Appl. No.: 19/169,199

(22) Filed: Apr. 3, 2025

(30) Foreign Application Priority Data
Apr. 17, 2024 (DE) 102024110783.9

(51) Int. Cl. F21S 41/29; B60Q 1/04; B60Q 1/26; B60Q 1/28; B60Q 1/30; B60Q 3/54; B60R 13/02; B60R 13/04; F21S 43/27

(52) U.S. Cl. CPC F21S 41/29; B60Q 1/2619; B60Q 1/28; B60Q 1/30; B60Q 3/54; B60R 13/02; B60R 13/04; F21S 43/27; B60Q 1/04

(57) ABSTRACT

The present invention relates to a composite component for integration into a lighting device of a motor vehicle, into a front or rear apron of a motor vehicle, or into an interior of a motor vehicle. The composite component includes a carrier and at least one front cover connected to the carrier, in particular in the form of a cover lens, a covering panel, or a decorative trim, wherein the front cover includes a body with a polyurethane coating.

### CROSS-REFERENCE TO RELATED APPLICATIONS

The present application claims the benefit of German Patent Application No. 10-2024-110-783.9, filed Apr. 17, 2024, the disclosure of which is incorporated by reference.

### FIELD OF THE INVENTION

The present invention relates to a composite component for integration into a lighting device of a motor vehicle, into a front or rear apron of a motor vehicle, or into a motor vehicle interior. Furthermore, the invention relates to a lighting device and a structural unit with a composite component of this kind, as well as a method for producing it.

### BACKGROUND OF THE INVENTION

In the area of the body or the interior of motor vehicles, there are various attractive applications for polyurethane (PUR) surface coatings. PUR coatings are characterized as protective coatings by high resistance, chemical resistance and to some extent existing self-healing abilities after mechanical damage. In addition, PUR coatings can form very smooth and aesthetically pleasing surfaces. Therefore, the focus is currently on applications of PUR coatings on the cover lenses of lighting devices, on covering panels of sensor devices, such as radomes, or on visible surfaces in the interior of motor vehicles.

One challenge is the efficient series production of such components with a polyurethane coating using multi-component injection molding, wherein the aim is to overmold the component injected in a first cycle with polyurethane in portions in a second cycle. In particular, the components to be integrated into the vehicle's bodywork, such as the cover lenses of lighting devices, usually have complex free-form geometries and often have undercuts. It has proved impractical to effectively seal the complex injection molding tools, which are equipped with slides, after the first step of injection with the comparatively low-viscosity polyurethane in the second step.

### SUMMARY OF THE INVENTION

It is the object of the present invention to propose an alternative embodiment of a component with a polyurethane (PUR) coating of the aforementioned type, which can be produced in particular efficiently and without manufacturing-related restrictions in terms of the geometries that can be reproduced by means of injection molding.

This object is achieved by a composite component according to an embodiment disclosed herein. Advantageous further embodiments of the invention are also disclosed herein.

The technical teaching of the invention discloses a composite component for integration into a lighting device of a motor vehicle, in a front or rear apron of a motor vehicle, or in a motor vehicle interior, comprising a carrier and at least one front cover, in particular in the form of a cover lens, a covering panel or a decorative trim, connected to the carrier, wherein the front cover comprises a body with a polyurethane coating.

The underlying idea of the invention is to divide the component into two parts that can be manufactured independently of one another: on the one hand, a front cover that is substantially flat and has a 2.5D geometry, for example, as a PUR-coated component; and on the other hand, a carrier with a geometry of any complexity that serves to structurally integrate the composite component into the installation environment of the motor vehicle. When producing the front cover using multi-component injection molding, the geometrically simple body injected in a first step can be easily overmolded with polyurethane in a second step. The carrier can be produced independently of the front cover, which means that it can advantageously involve different materials. Finally, the carrier and the at least one front cover are joined together to form the composite component according to the invention, wherein the carrier substantially assumes the function of a structural component and the PUR-coated front cover fulfills a protective function and, as a visible component, meets the desired aesthetic design requirements.

In particular, the carrier has a thermoplastic or thermosetting plastic, and/or the body of the front cover has a thermoplastic, for example a polycarbonate. The carrier can, for example, have synthetic Duroplasts such as synthetic resins and contain embedded glass fibers for reinforcement. Depending on the application addressed, the body of the front cover can be transparent, translucent or opaque.

In one embodiment, the carrier comprises at least one receptacle portion for receiving a component and/or at least one connecting portion for connection to a front or rear apron of a motor vehicle or to a motor vehicle interior. The carrier can thus serve as a central interface for the receptacle of electronic components, such as lighting or sensor devices, and for connection to the body of the motor vehicle. In particular, the carrier can be designed to be so rigid and stable that a component of the vehicle body, for example a cross beam, can be replaced by the carrier, i.e. the carrier can function as a structural component of the body. For this purpose, the carrier can be designed, for example, as a hybrid component comprising at least one metallic sheet-metal component and thus have increased rigidity and load-bearing capacity. Furthermore, the carrier can have a frame-like shape for enclosing at least one component to be received on the carrier.

The carrier and the front cover are either firmly connected to one another, in particular by means of a welded connection or an adhesive connection, or are detachable, in particular by means of a clamp or a screw connection. Preferably, the carrier and the front cover are connected in a media-tight manner, in particular against the penetration of moisture, for example using a separate sealing element in the case of a detachable connection.

In a further embodiment, the composite component comprises at least one rear cover connected to the carrier and arranged on a side of the carrier facing away from the front cover, wherein the carrier and the rear cover are preferably connected to one another in a releasable and/or media-tight manner. The rear accessibility with a detachable rear cover provides extended assembly options for components to be installed on the inside of the housing-like carrier.

The invention also relates to a lighting device for a motor vehicle, comprising at least one composite component according to any of the aforementioned embodiments and a light module, wherein the front cover of the composite component is designed as a transparent cover lens, and/or wherein the light module is accommodated on the carrier of the composite component. In particular, the carrier can form a housing portion and can enclose the received light module around its entire circumference.

Furthermore, the invention relates to a structural unit for integration into a front or rear apron of a motor vehicle, at least comprising a composite component according to any of the aforementioned embodiments, a lighting device, a sensor device and/or a decorative element, wherein the composite component comprises a plurality of front covers that are designed as a cover lens for the lighting device, as a covering panel for the sensor device and/or as a decorative trim for the decorative element, and/or wherein the lighting device, the sensor device and/or the decorative element are accommodated on the carrier of the composite component. Thus, the composite component can be part of a large-area structural unit extending across the entire width of the vehicle and have a plurality of differently designed, PUR-coated front covers on a common carrier, for example transparent cover lenses of lighting devices and opaque covering panels in front of sensor devices.

The invention also discloses a method for producing a composite component according to any of the aforementioned embodiments, comprising at least the following steps in no particular order:
injection molding of the carrier from a thermoplastic or thermosetting plastic;
multi-component injection molding of the at least one front cover, wherein the body is injection molded from a thermoplastic material in a first step and overmolded with polyurethane in a second step, forming the PUR coating; and
connecting the carrier and the front cover to one another.

According to the invention, the carrier and the front cover are produced separately and independently of one another. The polyurethane coating is applied only to the comparatively simple geometry of the front cover, which does not present any process-related difficulties with regard to a mold seal against the low-viscosity polyurethane. In particular, the front cover is manufactured using either the turning/sliding technique or the core withdrawal technique. When the carrier is injection molded, sheet-metal components can be placed in the mold and overmolded to form a carrier that is an extremely rigid and load-bearing hybrid component.

In one process variant, the carrier and the front cover are joined by welding, wherein the welded connection is subsequently heated to reduce tension. Such heat treatment is particularly advantageous when the components to be joined are made of polycarbonate, as it significantly reduces the probability of stress cracking in the area of the welded connection, which could compromise the media tightness. The local temperature increase caused by the heat treatment and the duration of treatment must be adapted to the specific materials used in each application, so that the intended stress relief is achieved to an appropriate extent without impairing the integrity of the welded connection.

### BRIEF DESCRIPTION OF THE DRAWINGS

Further measures that improve the invention are described in more detail below, together with the description of preferred exemplary embodiments of the invention, with the aid of the schematic figures. In the figures:

FIG. 1 is a first exemplary embodiment of a composite component;

FIG. 2 is a second exemplary embodiment;

FIG. 3 is a third exemplary embodiment;

FIG. 4 is a fourth exemplary embodiment; and

FIG. 5 is a structural unit according to the invention.

### DETAILED DESCRIPTION OF THE CURRENT EMBODIMENT

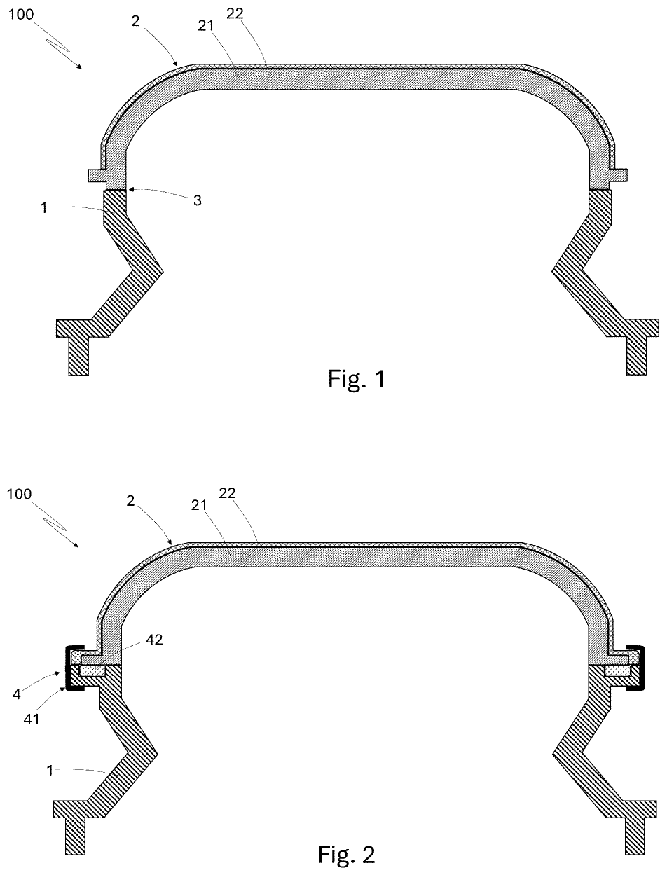

FIG. 1 through FIG. 4 show schematic sectional views of exemplary embodiments of the composite component 100 according to the invention, comprising the carrier 1 and the front cover 2 connected thereto, which has the body 21 with the polyurethane coating 22. The front cover 2 has the shape of a flat bowl, with a flat central portion and a peripheral edge portion for connecting to the carrier 1. The injection-molded body 21 is overmolded on the outside with the PUR coating 22. The carrier 1, as a component manufactured separately in single-component injection molding, can form a substantially more complex free form, wherein the carrier 1 in the exemplary embodiments has a housing- or frame-like shape and is closed at the front by the front cover 2.

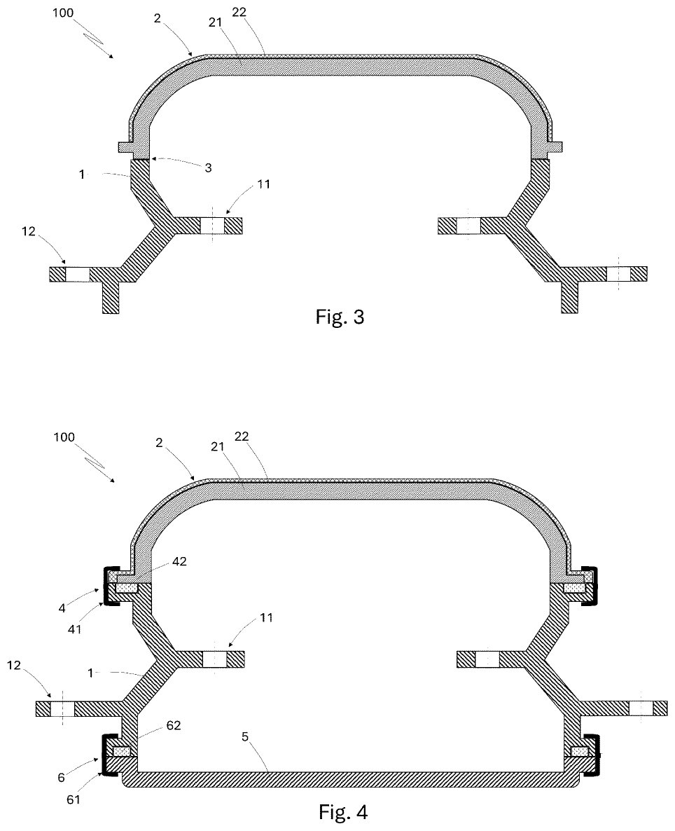

In the exemplary embodiments of FIG. 1 and FIG. 3, the carrier 1 and the front cover 2 are connected to one another in a materially and media-tight manner by means of the fully circumferential welded connection 3. For this purpose, the carrier 1 and the body 21 are each made of a polycarbonate. To ensure that the media are sealed in, the welded connection 3 has preferably undergone subsequent heat treatment to reduce tension.

In the exemplary embodiments of FIG. 2 and FIG. 4, the carrier 1 and the front cover 2 are connected to one another in a detachable and media-tight manner by means of the fully circumferential clamping 4. The clamping 4 is realized by a plurality of brackets 41, wherein the carrier 1 has a circumferential sealing bed with the sealing element 42 received therein.

In the exemplary embodiments of FIG. 3 and FIG. 4, the carrier 1 respectively comprises the receptacle portions 11 for receiving a component in the interior of the housing formed by the carrier 1 and the front cover 2, in particular an electronic component such as a light module or a sensor device. Furthermore, carrier 1 comprises the connecting portions 12 for connecting to a front or rear apron of a motor vehicle.

In FIG. 4, the composite component 100 comprises the rear cover 5, which is arranged on the side of the carrier 1 facing away from the front cover 2. The carrier 1 and the back cover 5 are connected to one another in a detachable and media-tight manner by means of the clamp 6 with the brackets 61 and the surrounding sealing element 62. The detachable connections of both the front cover 2 and the rear cover 5 advantageously provide access to the inside of the carrier 1 from both sides 1 during assembly or maintenance of a component to be accommodated on the receptacle portions 11.

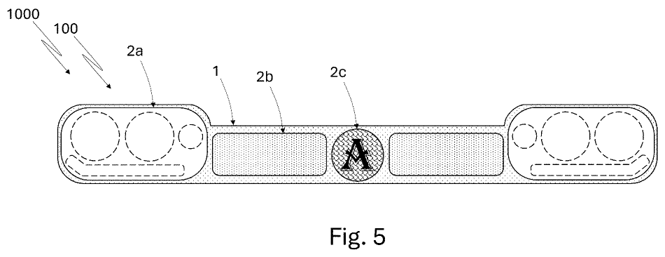

FIG. 5 shows a schematic front view of a structural unit 1000 for integration into a front apron of a motor vehicle, comprising the composite component 100 according to the invention, which has the carrier 1 and a plurality of front covers, which are formed as two transparent cover lenses 2a for front headlights to be arranged behind them, two opaque covering panels 2b for radar sensor devices and a centrally arranged, decorative trim panel 2c with the manufacturer's logo. The PUR coating is arranged on the facing front side of the front covers 2a, 2b, 2c. In particular, the carrier 1 can be designed as a reinforced hybrid component with metallic sheet-metal components and thus have a load-bearing capacity such that the headlights and the sensor devices can be attached to it.

### List of Reference Numerals

1 carrier
11 receptacle portion
12 connecting portion
2 front cover
2a cover lens
2b covering panel
2c decorative trim
21 body
22 polyurethane coating
3 welded connection
4 clamp
41 bracket
42 sealing element
5 rear cover
6 clamp
61 bracket
62 sealing element
100 composite component
1000 structural unit

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A composite component for integration into a lighting device of a motor vehicle, into a front or rear apron of a motor vehicle, or into an interior of a motor vehicle, comprising:
a carrier; and
a front cover connected to the carrier, the front cover comprising a cover lens, a covering panel, or a decorative trim, wherein the front cover further comprises a body with a polyurethane coating.

2. The composite component of claim 1, wherein the carrier has a thermoplastic or thermosetting plastic, and wherein the body has a thermoplastic plastic.

3. The composite component of claim 1, wherein the carrier is configured as a hybrid component comprising at least one sheet-metal component.

4. The composite component of claim 1, wherein the carrier and the front cover are connected to one another in a materially integral manner by means of a weld or an adhesive connection.

5. The composite component of claim 1, wherein the carrier and the front cover are detachably connected to one another by means of a clamp or a screw connection.

6. The composite component of claim 1, wherein the carrier and the front cover are connected to one another in a media-tight manner.

7. The composite component of claim 1, wherein the carrier comprises a receptacle portion for receiving a component for connection to an apron of a motor vehicle or for connection to an interior of a motor vehicle.

8. The composite component of claim 1, wherein the carrier has a frame-like shape for enclosing on the outside a component to be received on the carrier.

9. The composite component of claim 1, further comprising a rear cover connected to the carrier and arranged on a side of the carrier facing away from the front cover.

10. The composite component of claim 9, wherein the carrier and the back cover are connected to each other in a releasable and media-tight manner.

11. A lighting device for a motor vehicle, comprising:
a lighting module; and
the composite component of claim 1, wherein the front cover of the composite component is configured as a transparent lens, and wherein the lighting module is accommodated on the carrier of the composite component.

12. A structural unit for integration into a front or rear apron of a motor vehicle, comprising:
the composite component of claim 1; and
a lighting device, wherein the composite component comprises a plurality of front covers which are configured as a cover lens for the lighting device, and wherein the lighting device is accommodated on the carrier of the composite component.

13. A structural unit for integration into a front or rear apron of a motor vehicle, comprising:
the composite component of claim 1; and
a sensor device, wherein the composite component comprises a plurality of front covers which are configured as a covering panel for the sensor device, and wherein the sensor device is accommodated on the carrier of the composite component.

14. A structural unit for integration into a front or rear apron of a motor vehicle, comprising:
the composite component of claim 1; and
a decorative element, wherein the composite component comprises a plurality of front covers which are configured as a decorative panel for the decorative element, and wherein the decorative element is accommodated on the carrier of the composite component.

15. A method for producing the composite component according to claim 1, comprising:
injection molding the carrier from a thermoplastic or thermosetting plastic;
multi-component injection molding the front cover, wherein the body is injection molded from a thermoplastic material in a first step and overmolded with polyurethane in a second step, forming a polyurethane coating; and
connecting the carrier and the front cover to one another.

16. The method of claim 15, wherein connecting the carrier and the front cover to one another includes welding the carrier and the front cover together to form a welded connection, the method further comprising heating the welded connection to reduce tension therein.
